(19) United States
(12) Patent Application Publication
(10) Pub. No.: US 2015/0025958 A1
(43) Pub. Date: Jan. 22, 2015

(54) COLLABORATION MONITOR FOR CROSS-MEDIA MARKETING CAMPAIGN DESIGN

(71) Applicant: XEROX CORPORATION, Norwalk, CT (US)

(72) Inventors: Dale Ellen Gaucas, Penfield, NY (US); Kirk J. Ocke, Ontario, NY (US); Michael David Shepherd, Ontario, NY (US)

(21) Appl. No.: 13/943,244

(22) Filed: Jul. 16, 2013

(51) Int. Cl. G06Q 30/02

(52) U.S. Cl. CPC G06Q 30/0244
USPC 705/14.43

(57) ABSTRACT

The present invention generally relates to systems and methods for assessing a multi-media marketing campaign under development. The techniques presented assess, for example, whether pairs of touchpoints of the campaign are compatible in terms of best practices related to content and style and whether contributors to the touchpoints are effectively collaborating.

### FIELD OF THE INVENTION

This invention relates generally to marketing campaigns.

### SUMMARY

According to an embodiment, a system for monitoring collaboration in cross-media marketing campaign design is presented. The system includes a threshold store configured to store a threshold value for at least one similarity measure, a content analysis component configured to determine a similarity measure of a pair of touchpoints of a marketing campaign, a rules component configured to determine whether at least one rule regarding the campaign is met based upon at least one similarity measure obtained from the content analysis component and at least one threshold obtained from the threshold store, and a dashboard component configured to provide a display of, based on whether the at least one rule is met, at least one of: an overall campaign collaboration assessment, a particular touchpoint pair collaboration assessment, and a touchpoint collaboration alert, where the system is configured to interface with a campaign design environment to obtain touchpoint information.

Various optional features of the above system include the following. The content analysis component can be further configured to measure at least two of: textual compatibility between the pair of touchpoints, visual compatibility between the pair of touchpoints, and audio compatibility between the pair of touchpoints. The content analysis component can be further configured to measure: a tone of at least one interactive dialogue regarding design of a first touchpoint, and a degree of collaboration regarding design of the first touchpoint. The system can include a campaign model component communicatively coupled to the campaign design environment, where the campaign model component is configured to store campaign metadata of at least one campaign touchpoint. The system can further include a controller component configured to direct the rules component to determine whether at least one rule regarding the campaign is met and to provide information regarding whether the at least one rule is met to the dashboard component. The controller component can be configured to receive user input invoking the at least one rule. The system can include a campaign mining component configured to mine at least one prior campaign for the at least one threshold value. The overall campaign collaboration assessment can be one of a discrete number of quantized items. The system can include a campaign design environment configured to produce the marketing campaign. The content analysis component can be further configured to determine a sentiment measure for a dialog between contributors of a second pair of touchpoints of the marketing campaign, where the rules component is further configured to determine whether at least one sentiment rule regarding the campaign is met based upon at least one sentiment measure obtained from the content analysis component and at least one sentiment threshold obtained from the threshold store, and where the dashboard component is further configured to provide a display of, based on whether the at least one sentiment rule is met, at least one of: an overall campaign collaboration assessment, a particular touchpoint pair collaboration assessment, and a touchpoint collaboration alert.

According to an embodiment, a method for monitoring collaboration in cross-media marketing campaign design is presented. The method includes obtaining a threshold value for at least one similarity measure, interfacing with a campaign design environment to obtain information about a pair of touchpoints, determining a similarity measure of the pair of touchpoints, determining whether at least one rule regarding the marketing campaign is met based upon a comparison of the similarity measure of the pair of touchpoints with the threshold value, and providing for display, based on whether the at least one rule regarding the marketing campaign is met, at least one of: an overall campaign collaboration assessment, a particular touchpoint pair collaboration assessment, and a touchpoint collaboration alert.

Various optional features of the above embodiment include the following. The determining the similarity measure further can include measuring at least two of: textual compatibility between the pair of touchpoints, visual compatibility between the pair of touchpoints, and audio compatibility between the pair of touchpoints. The determining the similarity measure can further include measuring: a tone of at least one interactive dialogue regarding design of a first touchpoint, and a degree of collaboration regarding design of the first touchpoint. The method can further include storing campaign metadata of at least one campaign touchpoint. The method can further include directing the rules component to determine whether at least one rule regarding the campaign is met, and providing information regarding whether the at least one rule is met to the dashboard component. The method can further include receiving user input invoking the at least one rule. The method can further include mining at least one prior campaign for the at least one threshold value. The overall campaign collaboration assessment can be one of a discrete number of quantized items. The method can include producing the marketing campaign in a campaign design environment. The method can further include determining a sentiment measure for a dialog between contributors of a second pair of touchpoints of the marketing campaign, determining whether at least one sentiment rule regarding the marketing campaign is met based upon a comparison of the sentiment measure of the second pair of touchpoints with a sentiment threshold value, and providing for display, based on whether the at least one sentiment rule regarding the marketing campaign is met, at least one of: an overall campaign collaboration assessment, a particular touchpoint pair collaboration assessment, and a touchpoint collaboration alert.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 is a schematic diagram of a system according to some embodiments;

FIG. 2 is a schematic diagram of a dashboard according to some embodiments;

FIG. 3 is a flowchart according to some embodiments;

FIG. 4 is a flowchart according to some embodiments; and

FIG. 5 is a schematic diagram of a system according to some embodiments.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

Multiple contributors with disparate fields of expertise can create a cross-media marketing campaign using a collaborative model-based design environment. However, such environments permit the contributors to add content in an unstructured manner. In the absence of a detailed campaign brief, campaign quality and design efficiency can suffer. For example, a campaign with inconsistent messaging and content across print, email, and personalized webpage touchpoints (i.e., messages intended to be seen by a customer) can negatively affect the quality of the customer experience. As a more specific example, if an email touchpoint is a reminder of another email, then the emails should share some message content and therefore have some degree of textual similarity according to marketing best practices. Furthermore, lack of collaboration or unresolved differences during collaboration can adversely affect the timely completion of the campaign.

In general, embodiments provide a monitoring technique that mines and displays information about the degree of collaboration among the contributors during the process of creating a cross-media marketing campaign in a model-based design environment. Some embodiments base the information on analyses of the touchpoints. For example, embodiments can apply analysis techniques during the campaign creation process to detect how contributed content may or may not be compatible with content in other touchpoints. Further, embodiments can determine to what degree the content is agreed to by the contributors. The analysis techniques fall into several categories including: similarity of textual content and writing style or tone, similarity of graphical content and style such as color palette and mood, similarity of audio content such as music, and discourse and sentiment analysis of interactions such as comment threads about a touchpoint's content (e.g., degree of agreement/disagreement, etc.). Collaboration assessments can be based on threshold values that are determined from mining successful campaigns for content similarity measures between touchpoints. The techniques can assess collaboration based on knowledge of campaign best practices and on knowledge associated with the design components as represented in the model-based design environment.

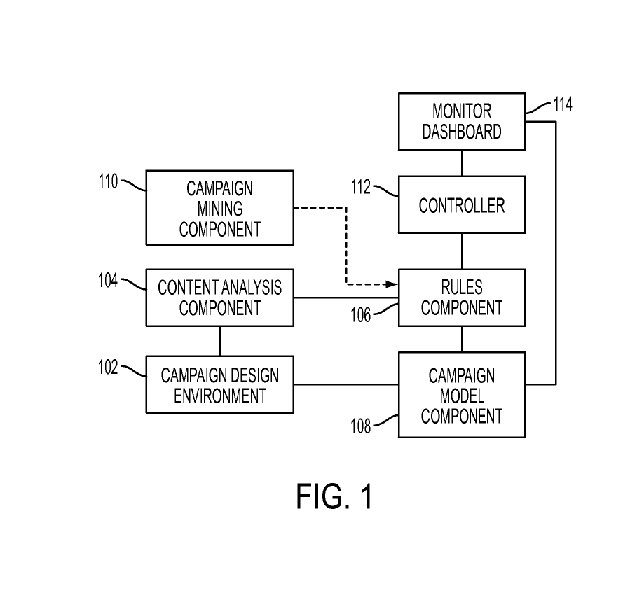

FIG. 1 is a schematic diagram of a system according to some embodiments. The system includes or interfaces with campaign design environment 102. Campaign design environment 102 permits contributors to create entire marketing campaigns. In particular, campaign design environment 102 can be a collaborative model-based design environment that permits the creation of multi-touchpoint cross-media marketing campaigns, and supports design contributions, content edits, and comment threads by multiple contributors. Touchpoints such as postcards, emails, landing pages, and websites may contain various types of content and can be represented (e.g., graphically represented) in campaign design environment 102. An example campaign design environment 102 is CIRCLE, available from XMPIE of New York, N.Y., a division of XEROX Corporation.

Touchpoints produced by campaign design environment 102 can have semantics associated with themselves and their content. Such semantics designate touchpoints and thereof as being of particular types or intended for particular uses. Examples of such semantics include a “postcard” label associated with a postcard touchpoint, and “address block” label associated with a particular portion of a postcard touchpoint.

Semantics can be provided within campaign design environment 102, or externally inferred. In some embodiments, e.g., if campaign design environment 102 supports an underlying domain model, semantics can be provided within campaign design environment 102. In such campaign design environments, semantics can be represented by metadata that is expressed directly from strongly-typed design components. U.S. patent application Ser. No. 13/412,450, filed Mar. 5, 2012 to Shepherd et al. and entitled, “Apparatus And Method For Facilitating Personalized Marketing Campaign Design” provides an example of how semantics can be associated with design components in an XMPIE CIRCLE campaign flow through the use of a campaign knowledge model and linguistic techniques. In other embodiments, semantic metadata can be inferred from the textual content within touchpoint design components, e.g., using linguistic tools. For example, semantics can be inferred using Bayesian classifiers trained with words that appear within the campaign flow's textual components.

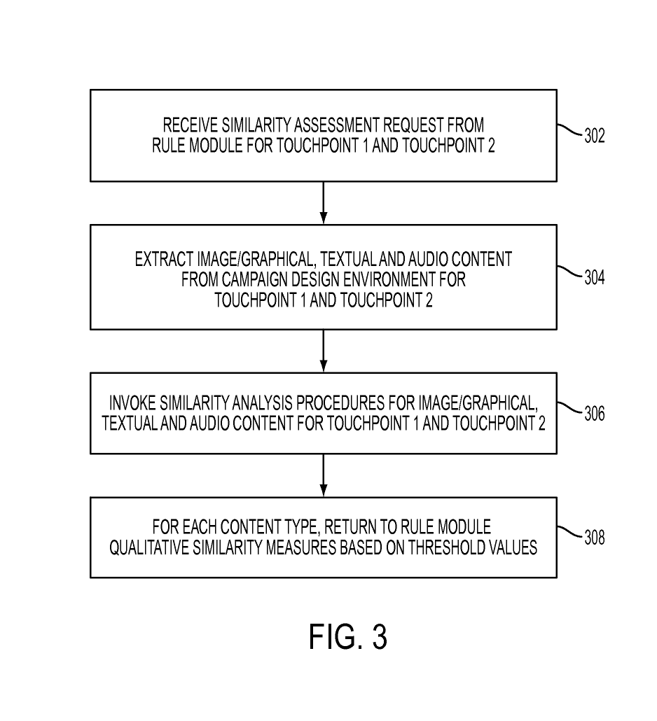

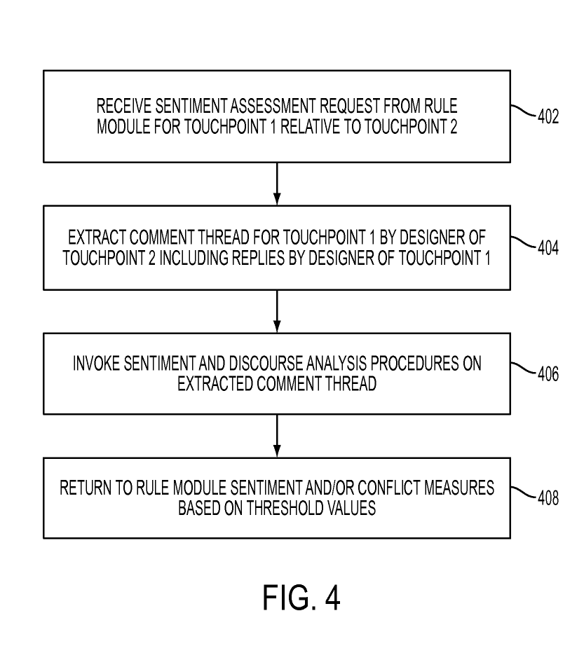

The system also includes content analysis component 104. In general, content analysis component 104 provides metrics (e.g., similarity and/or collaboration metrics) utilized by the system. As a first example of such metrics, content analysis component 104 can calculate a degree of textual compatibility between touchpoints based on known lexical techniques for textual similarity using analyses of vocabulary, writing style/tone, etc. This first example can utilize techniques disclosed in U.S. Pat. No. 8,209,339 entitled “Document Similarity Detection” to define a similarity measure by representing textual content of touchpoints as sets of term pairs, where a threshold level of term pair commonality determines similarity. As a second example, content analysis component 104 can calculate a degree of visual compatibility between touchpoints based on known visual similarity techniques for images, graphics, color palette, mood, etc. This second example can utilize color palette detection as employed by Colorific by 99designs of San Francisco, Calif. to define a similarity measure based on color palette comparison of the graphics in two different touchpoints. As a third example, content analysis component 104 can calculate a degree of audio compatibility between touchpoints based on known audio analysis algorithms, e.g., extent of rhythm and tempo similarity. As a fourth example, content analysis component 104 can quantize a tone of interactive dialogs such as comment threads about a touchpoint based on known techniques for discourse analysis and sentiment analysis, e.g., extent of agreement, conflict etc. An example of such a technique is a linguistic method to analyze exchanges in discussion threads to identify polarity of interactions as disclosed in, e.g., Amjad Abu-Jbara, AttitudeMiner: Mining Attitude from Online Discussions, Proc. NAACL-HLT 2012: Demonstration Session, pp. 33-36, Montreal Canada, Jun. 3-8, 2012. As a fifth example, content analysis component 104 can calculate a degree of collaboration on a touchpoint based on, e.g., a degree of participation by the contributors to the touchpoint, a number of edits by the contributors, and/or the extent of comment threads. These and other examples are discussed further below in reference to FIGS. 3 and 4.

The system further includes rules component 106. Rules component 106, per invocation by controller 112, executes rules that apply analysis procedures to content under development. In general, rules component 106 calculates any similarity measures requested in a rule consequent by calling the appropriate analysis procedures from content analysis component 104 on content in touchpoints created within campaign design environment 102. Threshold information encoded in the rules is obtained from campaign mining component 110, for example. Examples of rules include, by way of non-limiting example:
If a campaign's product offer postcard touchpoint and landing page website touchpoint are being created with sufficient content by separate contributors who have not added comments or explicit edits to each other's content, then calculate and record the touchpoints' textual similarity and graphical similarity measures.
If a campaign's product offer postcard touchpoint and landing page website touchpoint are being created by separate contributors and have a textual content similarity measure below some threshold value (specified by, e.g., campaign mining component 110), then display a status of the two touchpoints together on the dashboard with an visual indication of low textual compatibility and low collaboration.

There are also cases where high, and not low, textual similarity and graphical similarity between touchpoints may indicate a misunderstanding between designers. For example, if a campaign consists of a post card and an email with targets that are segmented into teenager and adult respectively, then it would be expected that the graphical and textual content may be significantly different. Thus, if the touchpoints have metadata indicating a target market segment, then rules component 106 could encode a rule that such a case should be monitored and displayed when content comparisons are not what are expected.

Rules component 104 may also invoke an analysis of comment threads, for example, if the number of comments exceeds some threshold value (e.g., as specified by campaign mining component 110). As an example, if the contributors to touchpoint1 and touchpoint2 should be collaborating, but the contributor to touchpoint2 posts critical comments about touchpoint1, or if the comments between the two contributors indicate conflict, then the two touchpoints may have compatibility issues.

The system also includes campaign mining component 110. Campaign mining component 110 mines successful campaigns to determine thresholds used by rules component 106 to evaluate rules. Campaign mining component 110 can also store such threshold values. Thresholds can be determined from mining successful campaigns for typical degrees of textual similarity and graphical similarity for touchpoints that are known to have semantic relationships, such as reminders, follow-ups, confirmations, etc.

In general, collaboration measures are calculated relative to similarity threshold values that are determined by mining the touchpoint content of a large number (e.g., hundreds) of successful campaigns. For example, if, when applying a specific textual similarity algorithm to product offer emails and offer reminder emails from numerous case studies yields a typical similarity measure S, then the value S can be used as a threshold value for determining whether the designers of two different touchpoints had a low or high degree of collaboration. A similar approach can be taken to analyze the image or graphical content of touchpoints for similarity in subject, color etc. Campaign mining component 110 can implement known techniques to analyze, for example, style in textual content, mood in graphical content, or rhythm and tempo in audio content to determine similarity threshold values from successful campaigns. Video similarity can also be considered. In the case of analyzing comment threads, discourse and sentiment analysis techniques can be used to determine degrees of agreement or disagreement that could be displayed depending on threshold values.

Mined similarity threshold values can also yield campaign best practice rules for implementation by rules component 106. For example, if a large number of successful campaigns have high similarity measures for color palette across touchpoints, then consistent color palette between two print touchpoints is desirable. If a campaign brief did not specify a color palette, this best practice would imply that designers of separate print touchpoints should have a large degree of collaboration that is reflected in high color palette similarity measures for the touchpoints' graphics.

The system also includes campaign model component 108. Campaign model component 108 keeps track of metadata associated with touchpoint components created in campaign design environment 102. Examples of such metadata include product offer postcard, event registration website, reminder postcard and confirmation email. Rules component 106 evaluates a rule antecedent based on information from the campaign model component 108.

The system also includes controller 112. Controller 112 invokes rules component 106 to calculate collaboration assessment values (e.g. based on content similarity measures) and selects results to return to monitor dashboard 114. The selection may be based on user-specified priorities or on explicit information requests from the user via the monitor dashboard. The collaboration assessment values can be binary (e.g., “OK” or “POSSIBLE PROBLEM”) or quantized (e.g., “GREEN”, “YELLOW” or “RED”).

The system also includes monitor dashboard 114. Monitor dashboard 114 provides for display of qualitative compatibility or collaboration measures provided by controller 112. For efficiency, controller 112 can be invoked on a pre-determined, periodic basis, or when specific events occur, e.g. a large amount of content is added to a touchpoint. Controller 112 can also be invoked by monitor dashboard 114 based on explicit user requests for compatibility or collaboration measures for specific touchpoints and specific types of content.

While the various functionalities of the system of FIG. 1 have been illustrated in terms of discrete components and the communication paths between them, embodiments need not be so configured. The components can be software modules, hardware modules, or any combination thereof. The functionalities of the various components need not be grouped as described herein. Other configurations of components with different sets of functionalities can be used in the alternative.

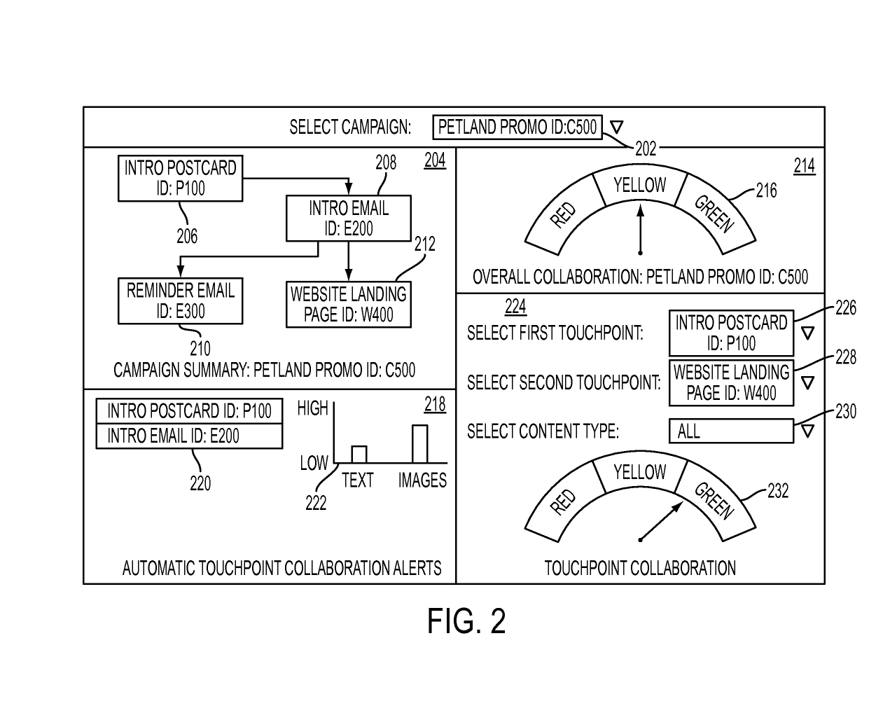

FIG. 2 is a schematic diagram of a dashboard according to some embodiments. The dashboard of FIG. 2 can be, for example, a display on a computer monitor of the information supplied by monitor dashboard 114. The dashboard includes several fields with which users can interact, as well as several user-viewable information portions.

For example, the dashboard includes a drop-down campaign selection field 202. A user can select a campaign using drop-down selection field 202 for further evaluation by the system. The dashboard also includes campaign summary portion 204. Campaign summary portion 204 includes a display representing touchpoints of the campaign selected at field 202. In particular, campaign summary portion illustrates intro postcard 206, intro email 208, reminder email 210 and website landing page 212. Arrows between touchpoints indicate campaign flow.

The dashboard also includes overall collaboration indicator portion 214. Overall collaboration indicator portion 214 includes overall collaboration indicator 216. As shown, overall collaboration indicator 216 provides a quantized display of the system's assessment of the overall collaboration of the selected campaign in terms of “GREEN”, “YELLOW” and “RED”. The overall collaboration assessment can be based on a combination of collaboration assessments for two or more touchpoints or touchpoint pairs. The combination can be, e.g., an average such as a mean.

The dashboard also includes automatic touchpoint collaboration alert portion 218. This portion automatically displays information about touchpoints that the system has determined have potential issues with respect to collaboration between contributors. As shown, automatic touchpoint collaboration alert portion 218 displays identifiers 220 of touchpoints that the system has detected might have collaboration problems. Touchpoint collaboration alert portion 218 also includes a display of a graph 222, which indicates a relative degree of collaboration on the touchpoints identified by identifiers 220 for text and images.

The dashboard also include manual touchpoint collaboration portion 224. Manual touchpoint collaboration portion 224 allows a user to select pairs of touchpoints using drop-down menus 226, 228 for analysis by the system. Manual touchpoint collaboration portion 224 also includes content type drop-down menu 230, which allows a user to select a content type for comparison. Manual touchpoint collaboration portion 224 also includes touchpoint collaboration indicator 232. As shown, touchpoint collaboration indicator 232 provides a quantized display of the system's assessment of the selected touchpoints and selected content type in terms of “GREEN”, “YELLOW” and “RED”.

FIG. 3 is a flowchart according to some embodiments. In particular, FIG. 3 depicts a technique for performing a similarity assessment of two touchpoints. The technique of FIG. 3 can be implemented using, e.g., the system of FIG. 1.

At block 302, the system receives a similarity assessment request, e.g., from rules component 106 of FIG. 1. The request can be in response to a manual request from a user (e.g., via manual touchpoint collaboration portion 224 of FIG. 2) or in response to an automatic assessment (e.g., as displayed in automatic touchpoint collaboration alert portion 218 of FIG. 2).

At block 304, the technique extracts any, or a combination, of image, graphical, textual, and audio content from the touchpoints. The extraction can be performed by, e.g., content analysis component 104 of FIG. 1.

At block 306, the technique invokes similarity analysis procedures for the content extracted at block 304. The similarity analysis procedures can be as described above in reference to content analysis component 104 of FIG. 1.

At block 308, the technique returns to rules component 106, for each content type, similarity measures based on threshold values. If multiple analysis procedures are used for a particular content type, the technique can return an aggregation (e.g., average) of the similarity measures returned by those multiple analysis procedures. This block can be performed as discussed above in reference to FIG. 1.

FIG. 4 is a flowchart according to some embodiments. In particular, the flowchart of FIG. 4 depicts a technique for analyzing touchpoint contributor agreement.

At block 402, the technique receives a sentiment analysis request along with identification of two or more touchpoints, e.g., from rules component 106. The request can be in response to a manual request from a user (e.g., via manual touchpoint collaboration portion 224 of FIG. 2) or in response to an automatic assessment (e.g., as displayed in automatic touchpoint collaboration alert portion 218 of FIG. 2).

At block 404, the technique extracts a comment thread for a first touchpoint by a contributor to the second touchpoint, including replies from contributor(s) to the first touchpoint.

At block 406, the technique invokes sentiment analysis and/or discourse analysis procedures on the extracted comment thread. This block can be performed by, e.g., content analysis component 104 of FIG. 1.

At block 408, the technique returns, e.g., to rules component 106 of FIG. 1, a sentiment and/or discourse result based on the analyses of block 406. This block can be performed according to the techniques discussed above in reference to FIG. 1.

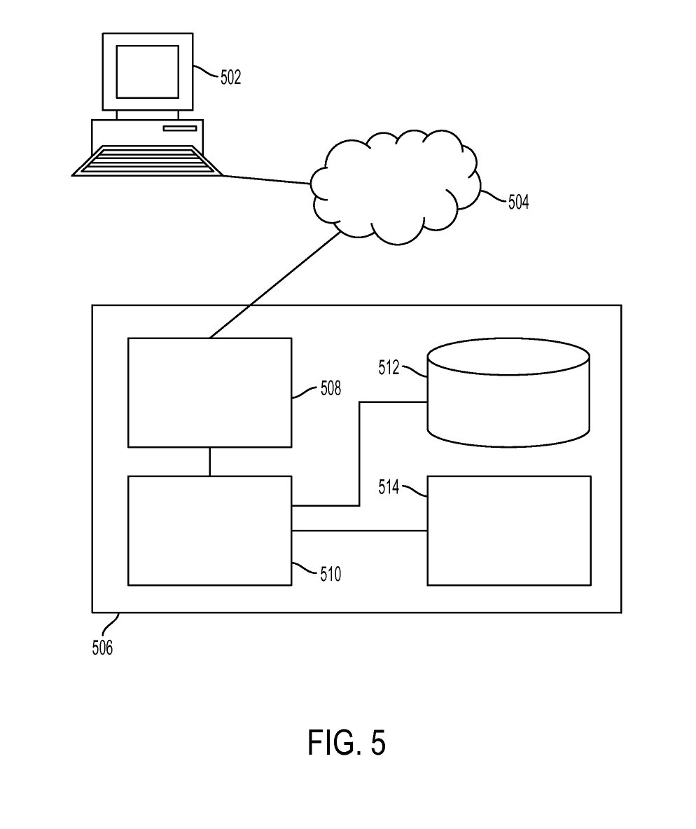

FIG. 5 is a schematic diagram of a system according to some embodiments. In particular, FIG. 5 illustrates various hardware, software, and other resources that can be used in implementations of systems and methods according to disclosed embodiments.

The system of FIG. 1 appears in FIG. 5 as block 510. That is, block 510 includes campaign design environment 102, content analysis component 104, rules component 106, campaign model component 108, and monitor dashboard 114. Campaign mining component 110 appears in FIG. 5 as block 514.

In embodiments as shown, system 510 can be implemented using a random access memory operating under control of or in conjunction with an operating system. System 510 in embodiments can be incorporated in one or more servers, clusters, or other computers or hardware resources, or can be implemented using cloud-based resources. System 510 can communicate with the data store 512, such as a database stored on a local hard drive or drive array, to access or store comparison results or other data. System 510 can further communicate with a network interface 508, such as an Ethernet or wireless data connection, which in turn communicates with one or more networks 504, such as the Internet or other public or private networks, via which instructions can be received from client device 502, or other device or service. Client device 502 can be, e.g., a portable computer, a desktop computer, a tablet computer, or a smart phone.

Other configurations of system 510, associated network connections, and other hardware, software, and service resources are possible.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A system for monitoring collaboration in cross-media marketing campaign design, the system comprising:
a threshold store configured to store a threshold value for at least one similarity measure;
a content analysis component configured to determine a similarity measure of a pair of touchpoints of a marketing campaign;
a rules component configured to determine whether at least one rule regarding the campaign is met based upon at least one similarity measure obtained from the content analysis component and at least one threshold obtained from the threshold store; and
a dashboard component configured to provide a display of, based on whether the at least one rule is met, at least one of: an overall campaign collaboration assessment, a particular touchpoint pair collaboration assessment, and a touchpoint collaboration alert;
wherein the system is configured to interface with a campaign design environment to obtain touchpoint information.

2. The system of claim 1, wherein the content analysis component is further configured to measure at least two of: textual compatibility between the pair of touchpoints, visual compatibility between the pair of touchpoints, video compatibility between the pair of touchpoints, and audio compatibility between the pair of touchpoints.

3. The system of claim 1, wherein the content analysis component is further configured to measure: a tone of at least one interactive dialogue regarding design of a first touchpoint, and a degree of collaboration regarding design of the first touchpoint.

4. The system of claim 1, further comprising a campaign model component communicatively coupled to the campaign design environment, wherein the campaign model component is configured to store campaign metadata of at least one campaign touchpoint.

5. The system of claim 1, further comprising a controller component configured to direct the rules component to determine whether at least one rule regarding the campaign is met and to provide information regarding whether the at least one rule is met to the dashboard component.

6. The system of claim 5, wherein the controller component is configured to receive user input invoking the at least one rule.

7. The system of claim 1, further comprising a campaign mining component configured to mine at least one prior campaign for the at least one threshold value.

8. The system of claim 1, wherein the overall campaign collaboration assessment is one of a discrete number of quantized items.

9. The system of claim 1, further comprising a campaign design environment configured to produce the marketing campaign.

10. The system of claim 1, wherein the content analysis component is further configured to determine a sentiment measure for a dialog between contributors of a second pair of touchpoints of the marketing campaign;
wherein the rules component is further configured to determine whether at least one sentiment rule regarding the campaign is met based upon at least one sentiment measure obtained from the content analysis component and at least one sentiment threshold obtained from the threshold store; and
wherein the dashboard component is further configured to provide a display of, based on whether the at least one sentiment rule is met, at least one of: an overall campaign collaboration assessment, a particular touchpoint pair collaboration assessment, and a touchpoint collaboration alert.

11. A method of monitoring collaboration in cross-media marketing campaign design, the method comprising:
obtaining a threshold value for at least one similarity measure;
interfacing with a campaign design environment to obtain information about a pair of touchpoints;
determining a similarity measure of the pair of touchpoints;
determining whether at least one rule regarding the marketing campaign is met based upon a comparison of the similarity measure of the pair of touchpoints with the threshold value; and
providing for display, based on whether the at least one rule regarding the marketing campaign is met, at least one of: an overall campaign collaboration assessment, a particular touchpoint pair collaboration assessment, and a touchpoint collaboration alert.

12. The method of claim 11, wherein the determining the similarity measure further comprises measuring at least two of: textual compatibility between the pair of touchpoints, visual compatibility between the pair of touchpoints, video compatibility between the pair of touchpoints, and audio compatibility between the pair of touchpoints.

13. The method of claim 11, wherein the determining the similarity measure further comprises measuring: a tone of at least one interactive dialogue regarding design of a first touchpoint, and a degree of collaboration regarding design of the first touchpoint.

14. The method of claim 11, further comprising storing campaign metadata of at least one campaign touchpoint.

15. The method of claim 11, further comprising directing the rules component to determine whether at least one rule regarding the campaign is met; and providing information regarding whether the at least one rule is met to the dashboard component.

16. The method of claim 15, further comprising receiving user input invoking the at least one rule.

17. The method of claim 11, further comprising mining at least one prior campaign for the at least one threshold value.

18. The method of claim 11, wherein the overall campaign collaboration assessment is one of a discrete number of quantized items.

19. The method of claim 11, further comprising producing the marketing campaign in a campaign design environment.

20. The method of claim 11, further comprising:
determining a sentiment measure for a dialog between contributors of a second pair of touchpoints of the marketing campaign;
determining whether at least one sentiment rule regarding the marketing campaign is met based upon a comparison of the sentiment measure of the second pair of touchpoints with a sentiment threshold value; and
providing for display, based on whether the at least one sentiment rule regarding the marketing campaign is met, at least one of: an overall campaign collaboration assessment, a particular touchpoint pair collaboration assessment, and a touchpoint collaboration alert.
